(19) United States
(12) Patent Application Publication
(10) Pub. No.: US 2023/0363499 A1
(43) Pub. Date: Nov. 16, 2023

(54) MODULAR UTILITY TOOL

(71) Applicant: MODL, Inc., Dunwoody, GA (US)

(72) Inventors: Victor Barak ZITRON, Sandy Springs, GA (US); Zachary W. LEITZ, Dunwoody, GA (US); Justin GULD, Raleigh, NC (US)

(21) Appl. No.: 18/196,910

(22) Filed: May 12, 2023

Related U.S. Application Data
(60) Provisional application No. 63/341,412, filed on May 12, 2022.

(51) Int. Cl. A44B 13/00; F21V 33/00; B65D 51/24; B65D 51/28; B65D 41/04; B65D 1/02

(52) U.S. Cl. CPC A44B 13/0029; F21V 33/008; B65D 51/242; B65D 51/28; B65D 51/248; B65D 41/04; B65D 1/0246

(57) ABSTRACT

A modular utility tool can include a rigid link element and a flexible strap that is removably securable to the link element. The link element can include a plurality of studs shaped to mate with apertures defined through the flexible strap so that a plurality of constructs can be formed.

### PRIORITY

This application claims priority to and the benefit of U.S. Provisional Patent Application No. 63/341,412, filed May 12, 2022, the entirety of which is incorporated fully herein by reference.

### FIELD

The present invention relates generally to tools and, more particularly, to a modular utility tool configured to provide for a variety of uses such as tethers and retaining straps.

### BACKGROUND

There is a need to provide for a utility tool that allows the user a variety of ways to secure items together and other useful functions.

### SUMMARY

Certain embodiments of the present invention may comprise a modular utility tool including a rigid link element and a flexible strap that is removably securable to the link element. The link element can include a plurality of studs shaped to mate with apertures defined through the strap so that a plurality of constructs can be formed.

In one example embodiment, a modular utility tool can include a flexible strap and a link. The flexible strap comprises an elongated body in a longitudinal direction that includes a plurality of apertures defined therethrough perpendicular to the longitudinal direction. The link comprises a first strap attachment stud and a second strap attachment stud. Each of the first and second strap attachment studs comprises a neck portion and an enlarged head portion. The head portion defines a diameter greater than the neck diameter and greater than a diameter of the apertures defined through the flexible strap.

The elongated body of the flexible strap can comprise a series of adjacently-disposed donut-shaped portions that are connected on opposing sides with an adjacent donut portion, and wherein the plurality of apertures are defined as holes centered in each donut-shaped portion.

The link can comprise a rigid planar plate. The first strap attachment stud and the second strap attachment stud each protrude from a common planar side of the rigid planar plate.

The head portion of each of the first and second strap attachment studs can be spade-shaped, round, polygonal or other shapes.

The head portion of each of the first and second strap attachment studs can comprise a flat side and an opposing pointed side. The head portion of each of the first and second strap attachment studs further comprises a pair of parallel sides that span between the flat side and the pointed side. Each intersecting corner of the head portion of each of the first and second strap attachment studs can be rounded off.

The head portion of each of the first and second strap attachment studs can comprise a longitudinally inward facing side and a longitudinally outward facing side when viewed from a rear side of the modular utility tool. The inward facing side can be more elongated than the outward side. The inward facing side can define a flat distal surface connected to a base via a pair of adjacent facets on both an upper side and a lower side thereof. A width of the inward facing side can narrow as it extends from the base towards the flat distal surface. The outward facing side can share a common base with the inward facing side and tapers as it extends to a distal outward surface via a pair of linear sidewalls. In a top elevation view, the head portion of each of the first and second strap attachment studs can have a thickest portion at a midline and taper thinner toward the respective flat distal surface and distal outward surface.

The link can comprise a plate, which includes a pair of opposing broad sides. The first strap attachment stud and the second strap attachment stud can each protrude from a common broad side of the plate. A rectangular aperture can be defined through the plate in a location between the first and second strap attachment studs. The rectangular aperture can be longitudinally centered between the first and second strap attachment studs. The rectangular aperture can have rounded corners. The rectangular aperture can be oriented perpendicular to a longitudinal length of the plate. The rectangular aperture can be sized to allow the flexible strap to pass through the link. The rectangular aperture can include a slot defined in a perimeter of the plate body to define an opening into the rectangular aperture.

The link can comprise a light accessory in the form of a bottle cap. The first strap attachment stud and the second strap attachment stud each can protrude from the bottle cap in a direction opposite one another. A compartment can be disposed on an inside of the bottle cap with a light disposed inside of the compartment.

The above summary is not intended to describe each illustrated embodiment, claimed embodiment or implementation of the invention. The detailed technology and preferred embodiments implemented for the subject invention are described in the following paragraphs accompanying the appended drawings for people skilled in this field to well appreciate the features of the claimed invention. It is understood that the features mentioned hereinbefore and those to be commented on hereinafter may be used not only in the specified combinations, but also in other combinations or in isolation, without departing from the scope of the present invention.

### BRIEF DESCRIPTION OF THE DRAWINGS

The invention may be more completely understood in consideration of the following detailed description of various embodiments of the invention in connection with the accompanying drawings, in which:

FIG. 1 shows a modular utility tool, in accordance with embodiments of the present invention.

FIG. 2 shows the modular utility tool of FIG. 1 with one end of the flexible strap released from the link element, in accordance with embodiments of the present invention.

FIG. 3 shows a portion of a modular utility tool comprising an alternative embodiment of the link element, in accordance with embodiments of the present invention.

FIG. 4 is a perspective view of a link element for a modular utility tool, in accordance with embodiments of the present invention.

FIG. 5 is a front view of a link element for a modular utility tool, in accordance with embodiments of the present invention.

FIG. 6 is a rear view of a link element for a modular utility tool, in accordance with embodiments of the present invention.

FIG. 7 is a first side view of a link element for a modular utility tool, in accordance with embodiments of the present invention.

FIG. 8 is a second side view of the link element of FIG. 4, opposite that of FIG. 7, in accordance with embodiments of the present invention.

FIG. 9 is a top view of a link element for a modular utility tool, in accordance with embodiments of the present invention.

FIG. 10 is a bottom view of a link element for a modular utility tool, in accordance with embodiments of the present invention.

FIG. 11 is a perspective view of a link element for a modular utility tool, in accordance with embodiments of the present invention.

FIG. 12 is a perspective view of a flexible strap for a modular utility tool, in accordance with embodiments of the present invention.

FIG. 13 is a top view of a flexible strap for a modular utility tool, in accordance with embodiments of the present invention.

FIG. 14 is a bottom view of a flexible strap for a modular utility tool, in accordance with embodiments of the present invention.

FIG. 15 is a first end view of a flexible strap for a modular utility tool, in accordance with embodiments of the present invention.

FIG. 16 is a second end view, opposite the first end, of a flexible strap for a modular utility tool, in accordance with embodiments of the present invention.

FIG. 17 is a first side view of a flexible strap for a modular utility tool, in accordance with embodiments of the present invention.

FIG. 18 is a second side view, opposite the first, of a flexible strap for a modular utility tool, in accordance with embodiments of the present invention.

FIG. 19 shows a portion of a modular utility tool, in accordance with embodiments of the present invention.

FIG. 20 is a perspective view of an example construct of and usage for a modular utility tool, in accordance with embodiments of the present invention.

FIG. 21 is a perspective view of another example construct of and usage for a modular utility tool, in accordance with embodiments of the present invention.

FIG. 22 is a perspective view of another example construct of and usage for a modular utility tool, in accordance with embodiments of the present invention.

FIG. 23 shows a front view of a link element for a modular utility tool, in accordance with embodiments of the present invention.

FIG. 24 is a perspective view of a link element for a modular utility tool, in accordance with embodiments of the present invention.

FIG. 25 is another perspective view of a link element for a modular utility tool, in accordance with embodiments of the present invention.

FIG. 26 is a rear view of a link element for a modular utility tool, in accordance with embodiments of the present invention.

FIG. 27 is a top view of a link element for a modular utility tool, in accordance with embodiments of the present invention.

FIG. 28 is a perspective view of a link element for a modular utility tool, in accordance with embodiments of the present invention.

FIG. 29 is a side view of a link element for a modular utility tool, in accordance with embodiments of the present invention.

FIG. 30 is a front view of a link element for a modular utility tool, in accordance with embodiments of the present invention.

FIG. 31 is a view of a link element joined with a flexible strap, in accordance with embodiments of the present invention.

FIG. 32 is a perspective view of a modular utility bottle accessory, in accordance with embodiments of the present invention.

FIG. 33 is another perspective view of a modular utility bottle accessory, in accordance with embodiments of the present invention.

FIG. 34 is a top view of a modular utility bottle accessory, in accordance with embodiments of the present invention.

FIG. 35 is a bottom view of a modular utility bottle accessory, in accordance with embodiments of the present invention.

FIG. 36 is a side view of a modular utility bottle accessory, in accordance with embodiments of the present invention.

FIG. 37 is another side view of a modular utility bottle accessory, in accordance with embodiments of the present invention.

FIG. 38 is a perspective view of a link element for a modular utility tool, in accordance with embodiments of the present invention.

FIG. 39 is a front view of a link element for a modular utility tool, in accordance with embodiments of the present invention.

FIG. 40 is a rear view of a link element for a modular utility tool, in accordance with embodiments of the present invention.

FIG. 41 is a first side view of a link element for a modular utility tool, in accordance with embodiments of the present invention.

FIG. 42 is a second side view of the link element for a modular utility tool, in accordance with embodiments of the present invention.

FIG. 43 is a top view of a link element for a modular utility tool, in accordance with embodiments of the present invention.

FIG. 44 is a bottom view of a link element for a modular utility tool, in accordance with embodiments of the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the invention is to cover all modifications, equivalents, and alternatives falling within the spirit and scope of the invention as defined by the appended claims.

### DETAILED DESCRIPTION OF THE INVENTION

Trademark terms referenced in this application, including MODL, are the property of MODL, Inc. No rights to and no license or other rights to these trademarks are either conveyed, or intended to be conveyed, to any person or entity.

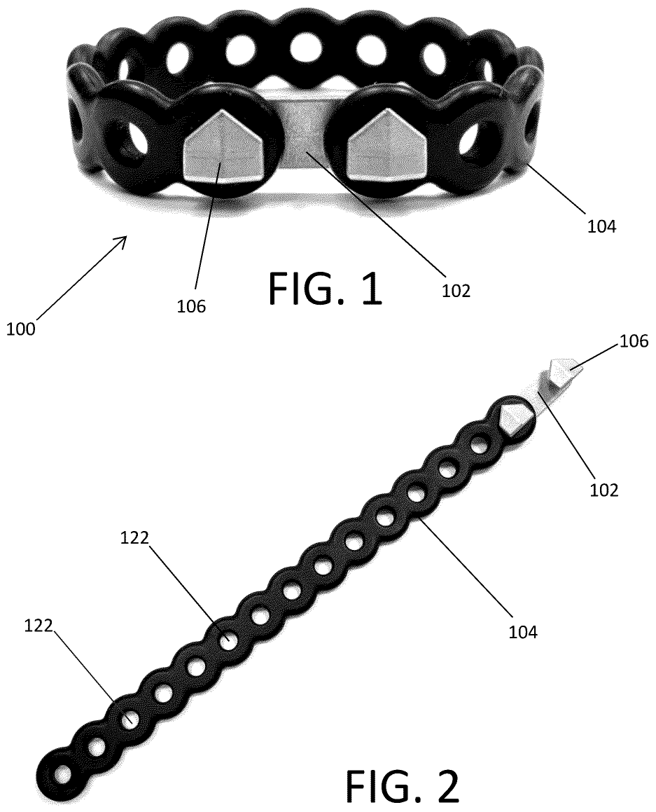

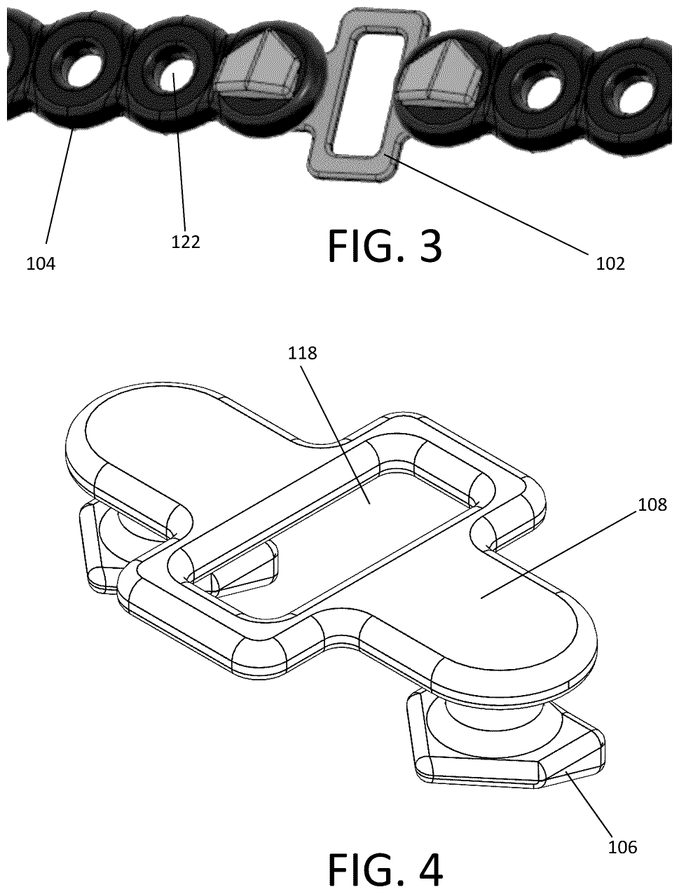

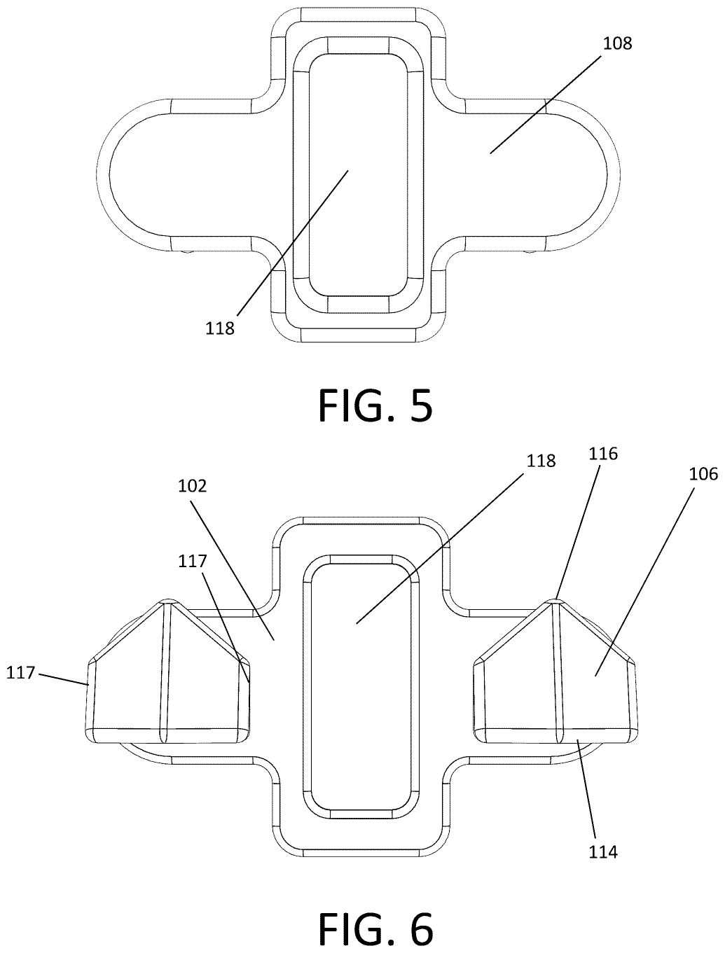

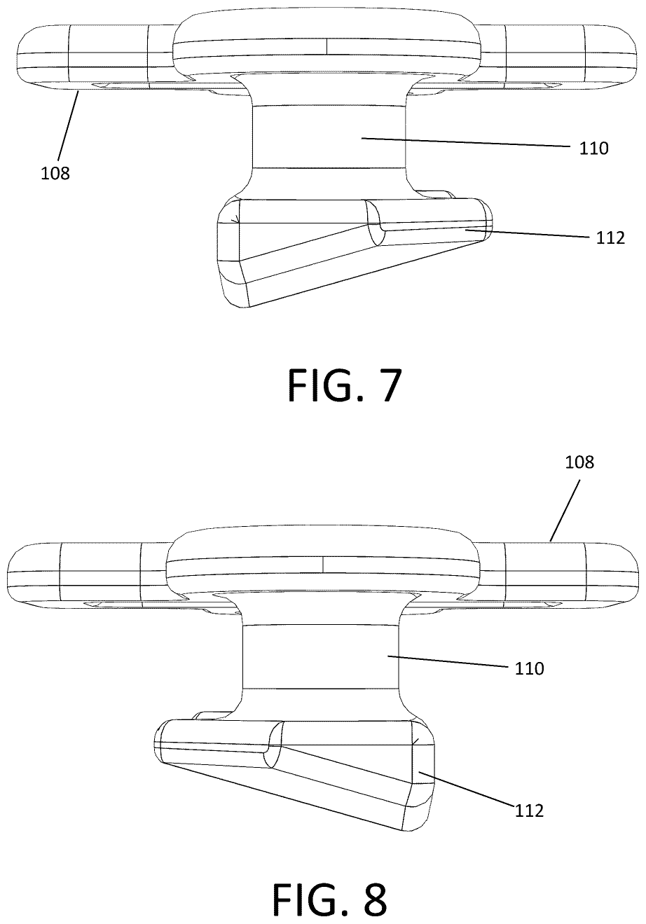

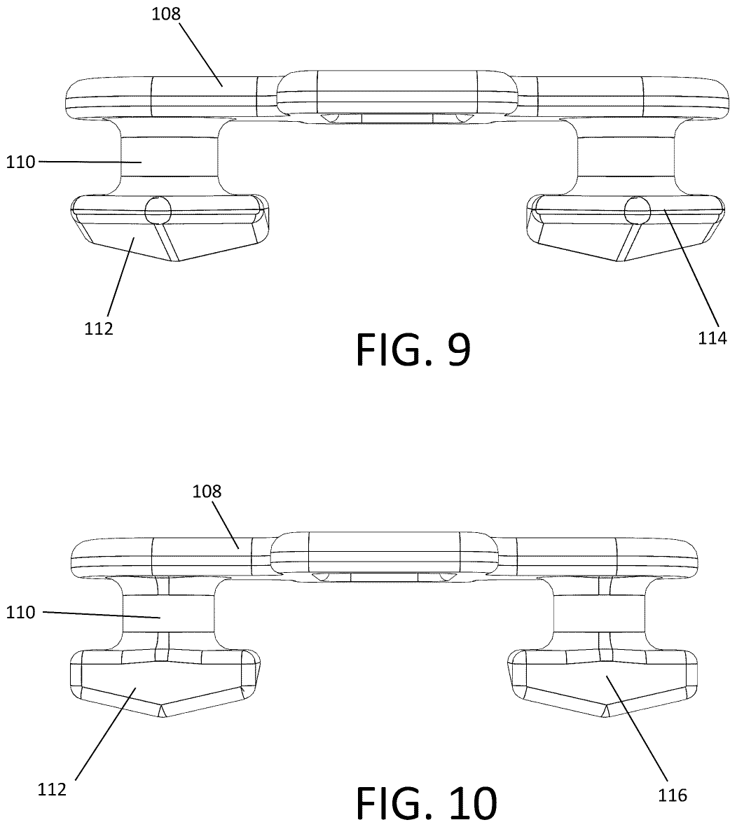

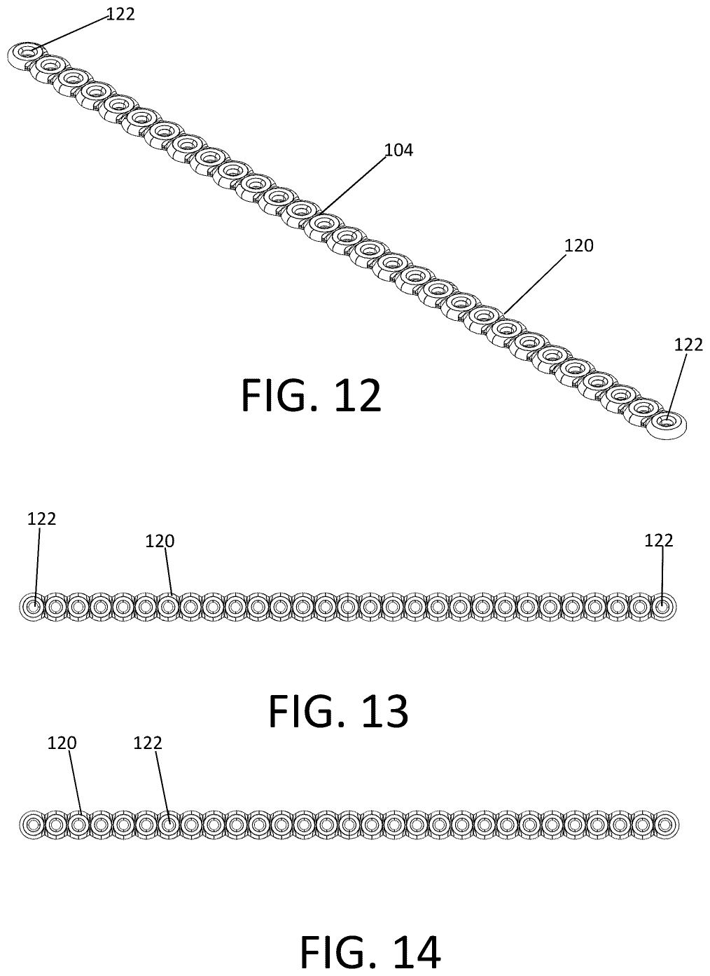

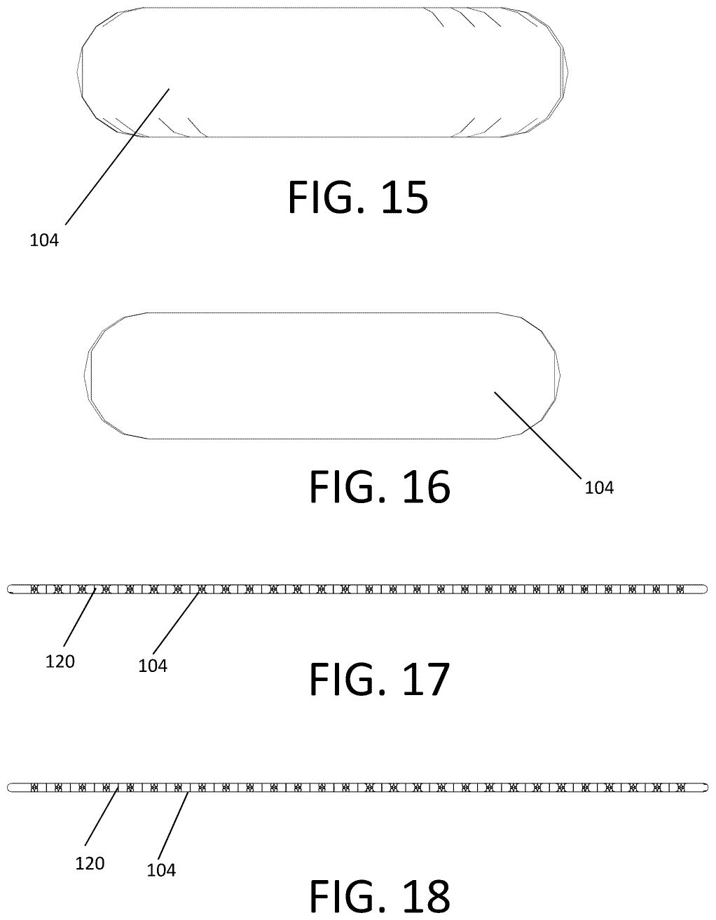

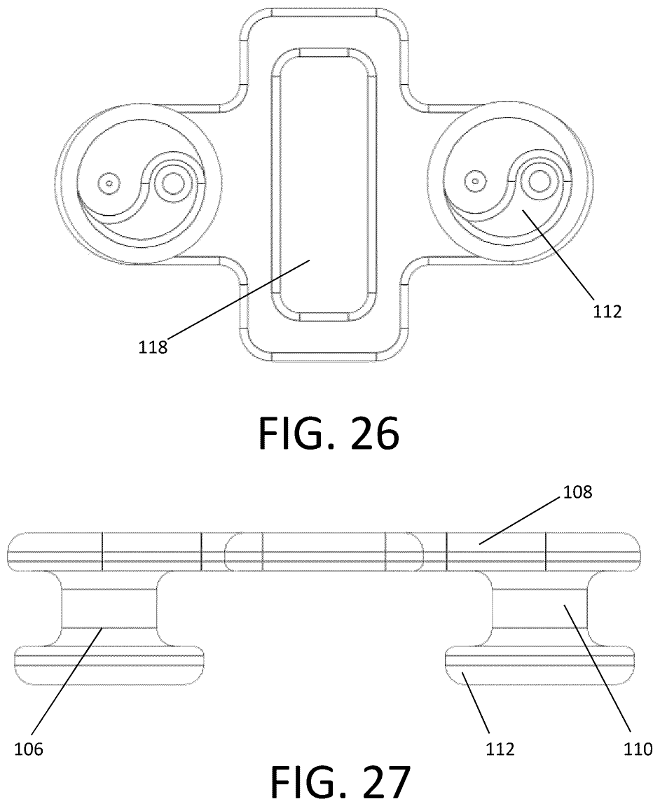

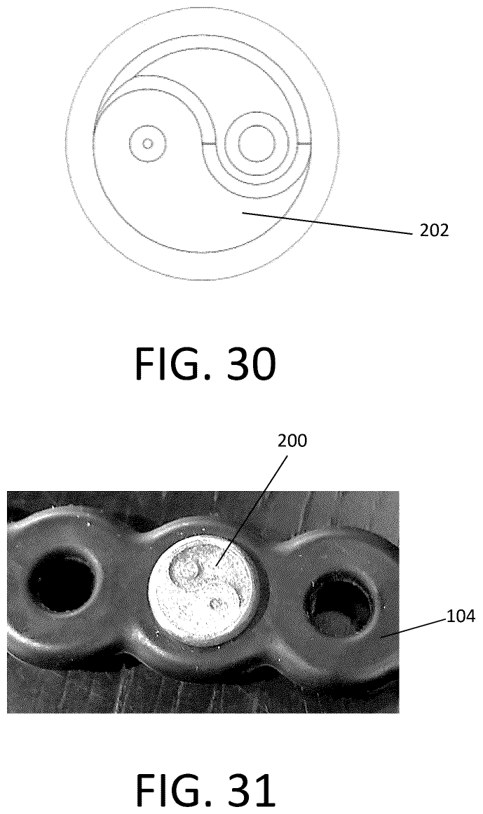

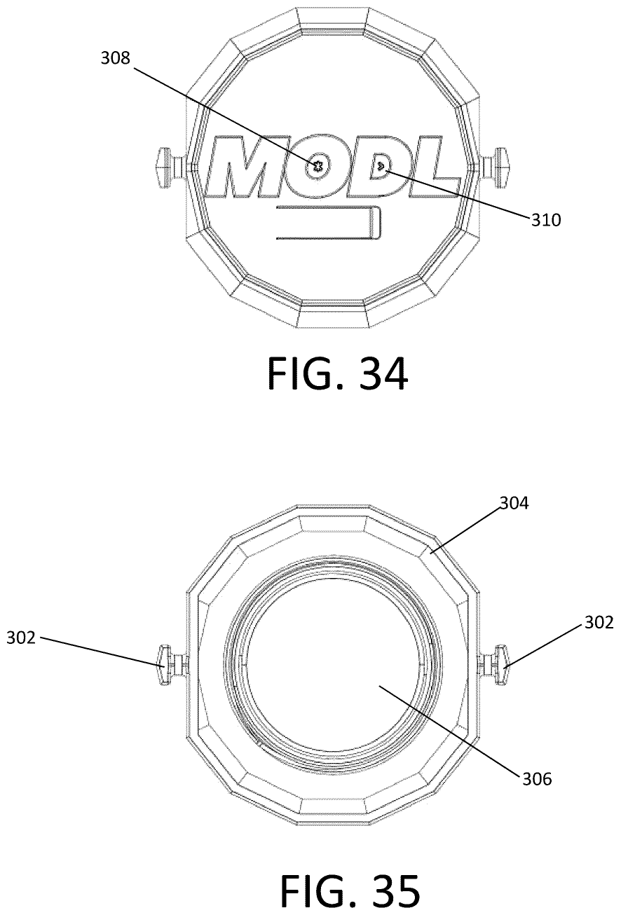

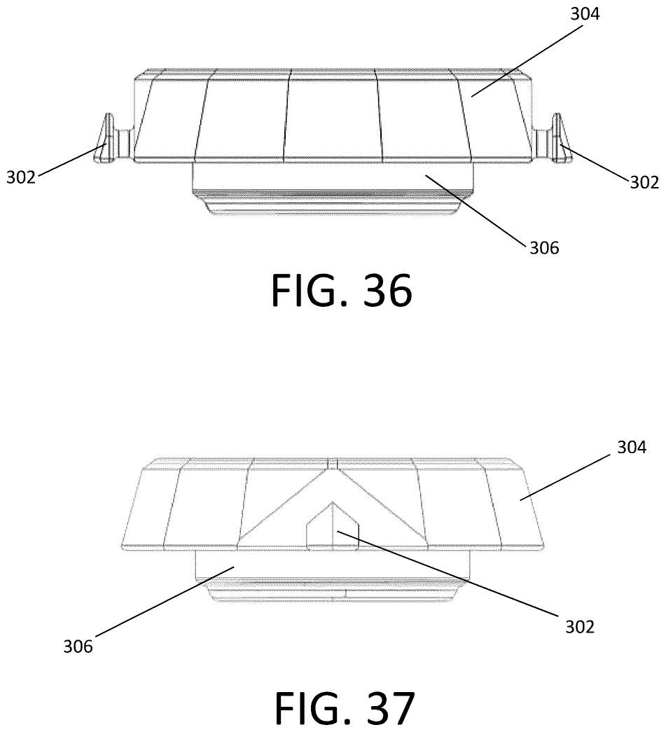

Referring generally to FIGS. 1-44, a modular utility tool 100 and its various assemblies, components, mods, structures, and certain example constructs and example usages are provided. The modular utility tool 100 is configured to be particularly useful for hikers, campers, cyclists, climbers, pet owners, and the like. The modular utility tool 100 can be combined with one or more additional tools, or components thereof, to form an even larger number of potential constructs.

Referring particularly to FIGS. 1-10, the modular utility tool 100 comprises a link 102 and a flexible strap 104 that is removably securable to the link element. The link 102 includes a plurality of studs 106 protruding outward from a side face thereof. Each stud 106 is shaped to mate with an aperture 122 defined through the strap 104 so that a plurality of constructs can be formed. More specifically, the shape of the stud 106 secures the strap 104 to the link element 102 until the user applies sufficient force to deform the aperture 122 and remove the strap from the stud 106.

In one example embodiment, the link element 102 comprises a planar (or substantially planar) plate 108 and a pair of studs 106 protruding outwardly from one of the broad planar sides of the plate 108. Each stud 106 comprises a neck portion 110 and an enlarged head portion 112. The head 112 defines a diameter greater than the neck diameter. The head diameter is also larger than the diameter of the aperture 122 defined in the strap 104. The neck portion 110 diameter is approximately the same as or slightly smaller than the diameter of the aperture 122 defined in the strap 104. More than two studs 106 can also be provided on a given link element 102.

In a rear view (e.g., FIG. 6), the head 112 of each stud 106 is generally spade-shaped. More particularly, the head 112 defines a flat side 114 and an opposing pointed side 116. The lateral sides 117 spanning between the flat side 114 and pointed side 116 are also flat and parallel to one another. The lateral sides 117 intersect the flat side 114 at a ninety degree angle. Each of the corners of the head 112 is rounded off.

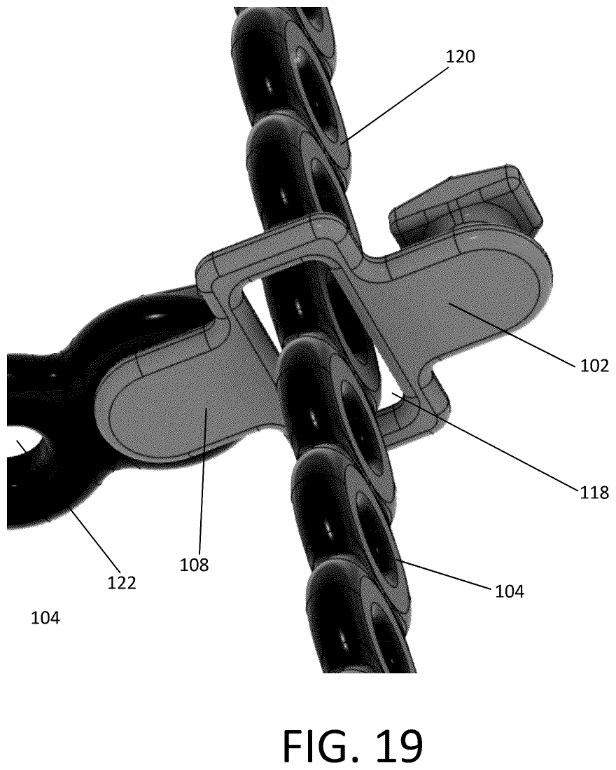

A rectangular aperture 118 is defined through the plate 108 at a mid-length thereof. The rectangular aperture 118 can be centered between the pair of studs 106. The aperture 118 is shaped as a rectangle with rounded corners. The aperture is oriented perpendicular to the longitudinal (major) length of the plate 108. The aperture 118 is sized to allow the strap 104 to pass therethrough such as shown in FIG. 19. This arrangement allows for in-line connection of flexible strap 104 and also allows for a “tightening” ability where the flexible strap 104 passes through the rectangular aperture 118 such that the flexible strap 104 can be cinched down tight around an object.

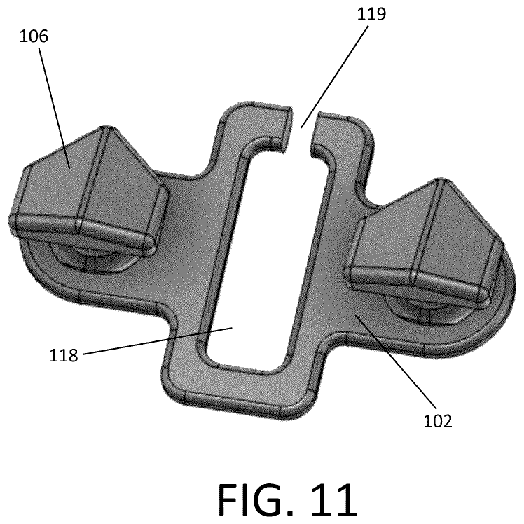

As shown in FIG. 11, the link element 102 can also include a slot 119 defined in a perimeter of the body 108 to define an opening into the rectangular aperture 118. This allows the top or bottom edge of the flexible strap 104 to pass through the slot 119 and into the aperture 118.

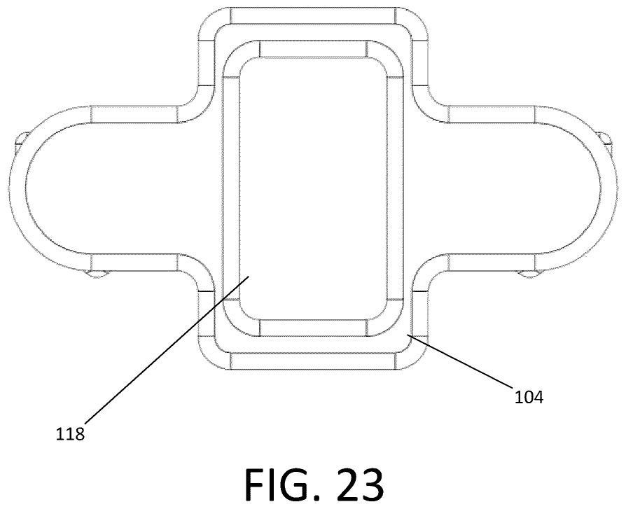

The aperture 118 can be varied in shape and proportion in additional embodiments. For example, the aperture 18 in the link element in FIG. 23 is slightly wider longitudinally than the embodiment depicted in FIGS. 4-10.

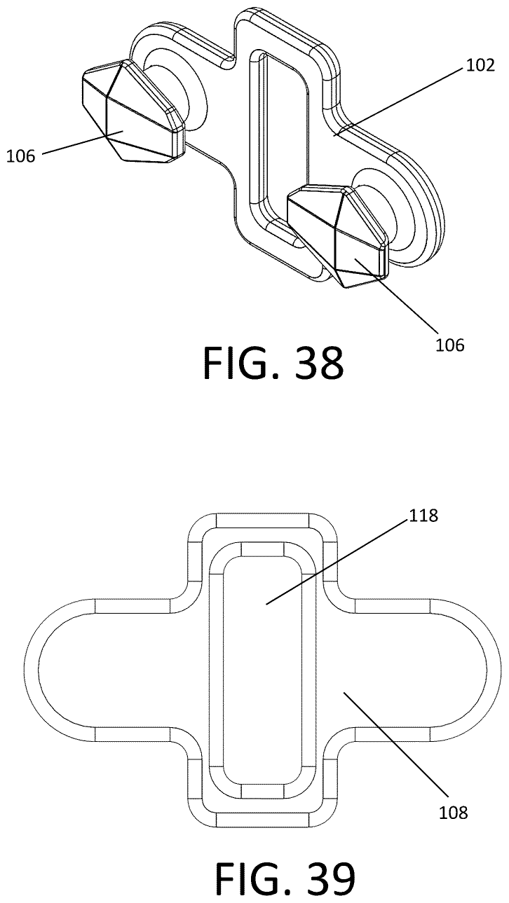

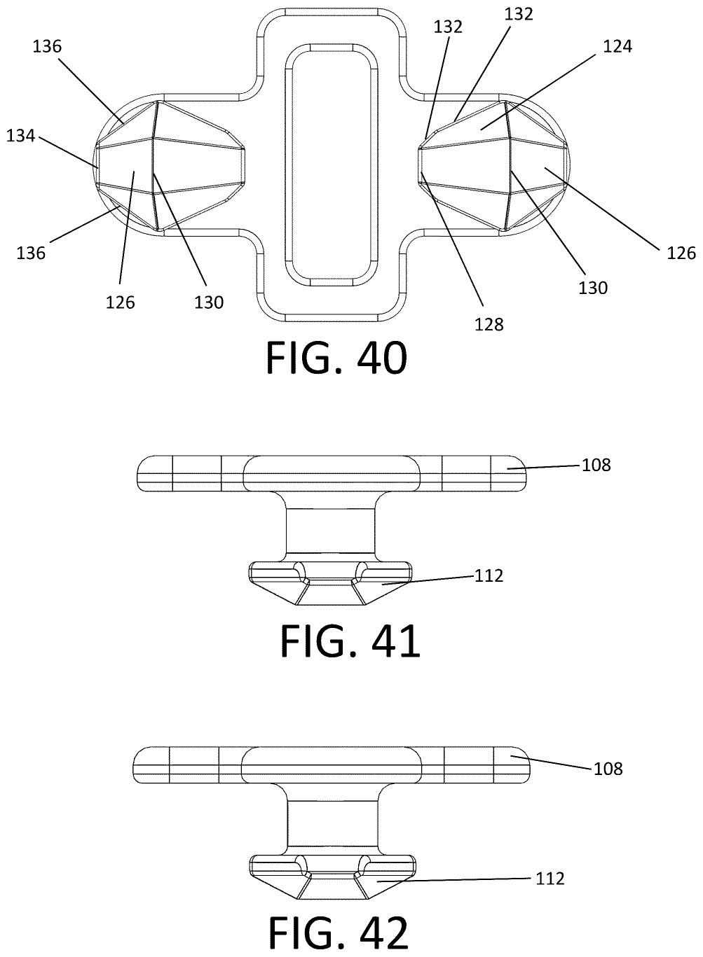

Referring particularly to FIGS. 38-44, a further embodiment of the link element 102 is shown. In this embodiment, the head 112 of each stud 106 is multi-faceted. More particularly, the head 112 defines an inward facing side 124 and an outward facing side 126 when viewed from the rear side of the link element 102 (FIG. 40). The inward facing side 124 is more elongated than the outward side and defines a flat distal surface 128 connected to a base 130 via a pair of adjacent facets 132 on both the upper and lower sides. As shown in the rear view, the width of the inward facing side 124 narrows as it extends from the base 130 towards the flat distal surface 128. The outward facing side 126 shares a common base 130 and tapers as it extends to a distal outward surface 134 via a pair of linear sidewalls 136. Again, each of the corners of the head 112 can be rounded off.

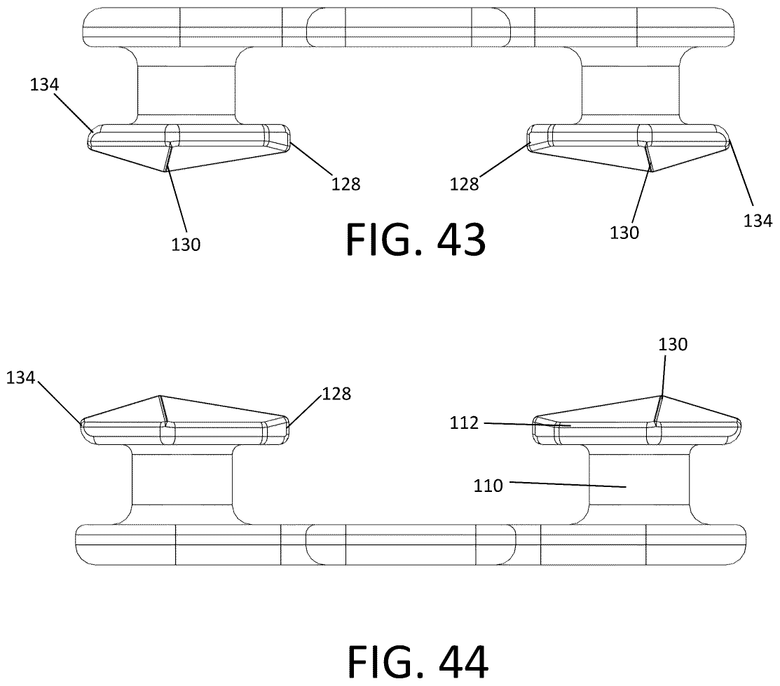

In the top or bottom elevation views (FIGS. 43-44), it can be seen that the heads 112 of each stud 106 have a thickest (highest peak in these views) portion at the midline 130 and taper inward/outward (horizontally in FIGS. 43-44) toward the respective flat distal surface 128 and distal outward surface 134. These respective flat distal surface 128 and distal outward surface 134 of the studs 106 for this embodiment of the link element 102 communicate or signal visually to the user where the best point is to put the aperture 122 of the strap 104 over the stud head 112. Thus, it can be understood that the securing movement of the aperture 122 of the head 112 for this embodiment is in the longitudinal direction versus being in the lateral direction (i.e. perpendicular to the long axis of the link plate 108) for the embodiment of FIGS. 4-10. The operational direction of the embodiment of FIGS. 38-44 is believed to be more intuitive for the user to operate while being less likely to become unintentionally unsecured.

The link element 102 can be formed of a rigid metal, plastic or composite material. For example, the link element 102 can be formed of stainless steel or an aluminum alloy. The link can also be formed of a ferrous metal and magnetized. In an alternative embodiment, the link element 102 is formed of a flexible material instead of a rigid material. For example, a rubber that is malleable or elastic can be employed. A mixed material link element can further be provided. For example, the plate 108 can be a flexible material while the studs 106 are a rigid material.

Referring particularly to FIGS. 1-2 and 12-18, the flexible strap 104 comprises an elongated flexible body 120 that includes an aperture 122 defined through the thickness of the body at each opposing end thereof. The body 120 can be configured as a series of adjacently-disposed donut shapes that are connected on opposing sides with an adjacent donut portion. Each donut portion includes an aperture 122 therethrough just like the opposing ends. Each aperture 122 has a diameter that is smaller than the diameter of the head 112 of the studs 106. The flexible strap 104 can be of any plural number of donut portions. The number of donut segments can be varied in size and shape, even within the same strap.

The flexible strap 104 is formed of a flexible material such as rubber or silicone. Other materials, such as leather, plastics and composites can also be provided. The flexible strap can also be formed from flexible metal braids. Metal or rigid reinforcements can be added to the flexible strap in certain alternatives as well. In another example, the strap is formed by molding silicone over a stronger base material such as polyurethane or metal wire. The flexible strap 102 can also be formed from a mixture of different materials.

In use, an aperture 122 of the strap 104 is stretched over the head 112 of a stud 106 until the aperture 122 deforms sufficiently to pass over the head 112 and mate with the neck portion 110. In this secured state, the donut segment of the flexible strap 104 lies front-to-rear between the head 112 and the plate 108. The stretching of the aperture 122 is facilitated by aligning the aperture 122 with the pointed side 116 of the head first and then applying force towards the flat side 114 and then towards the plate 110 until the aperture 122 is seated in the secured or engaged state as described above. The strap can be removed or disengaged from the stud 106 by reversing the process described above.

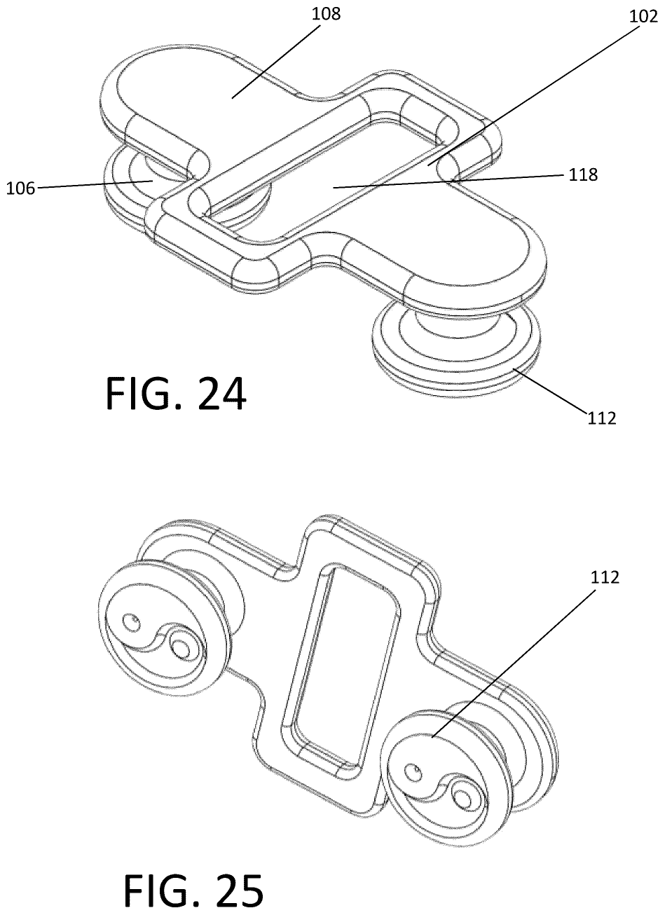

The shape of the head 112 of the studs 106 can be varied in other embodiments. For example, the head 112 of the studs 106 of the link element 104 in FIGS. 24-27 is circular. Other shapes, including polygonal shapes and complex shapes can also be employed. Each stud 106 of a link element 102 can also be different from one another or have a different clockwise orientation when viewed from the rear. Moreover, the outer face of each stud's head 112 can be provided with a decorative design, such as shown in FIGS. 25-26, 28 and 30-31.

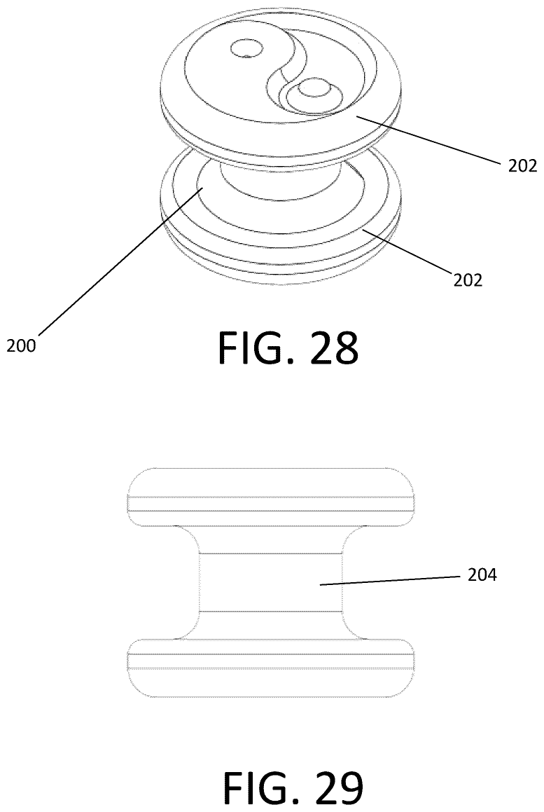

Referring to FIGS. 28-31, a stand-alone stud 200 is shown. The stand-alone stud 200 comprises opposing heads 202 with a narrowed neck 204 extending between the heads. One or both of the outer faces can be provided with a decorative appearance. The stand-alone stud 200 can be disposed through one of the apertures 122 in the strap 104. The neck can also be of sufficient length that the stand-alone stud 200 can be disposed through two overlapping apertures 122 of two straps (or overlapping portions of the same strap).

In a further embodiment, the studs 106 of a link element 102 can be removable and/or changeable. In one variant of this embodiment, the heads 112 of the studs are threaded into the neck portion 110, which allows the heads to be removed and replaced. In another variant, a threaded bore extends from the plate side 108 into the neck portion 110. A screw is provided, with the head on the plate side, to secure the stud 106 to the plate 108. In a further embodiment, the plate 108 can be provided with a male threaded shank and the neck portion with a female threaded bore. In a still further variant, the neck 110 has a female bore that fits over a male shank, and a grub screw is threaded into the neck portion 110 to secure the stud 106 in place. The female bore and shank can be toothed or eccentrically-shaped (e.g., D-shaped) to eliminate relative rotational movement.

In an alternative, the studs 106 are secured to the plate 108 by a button engagement/release mechanism.

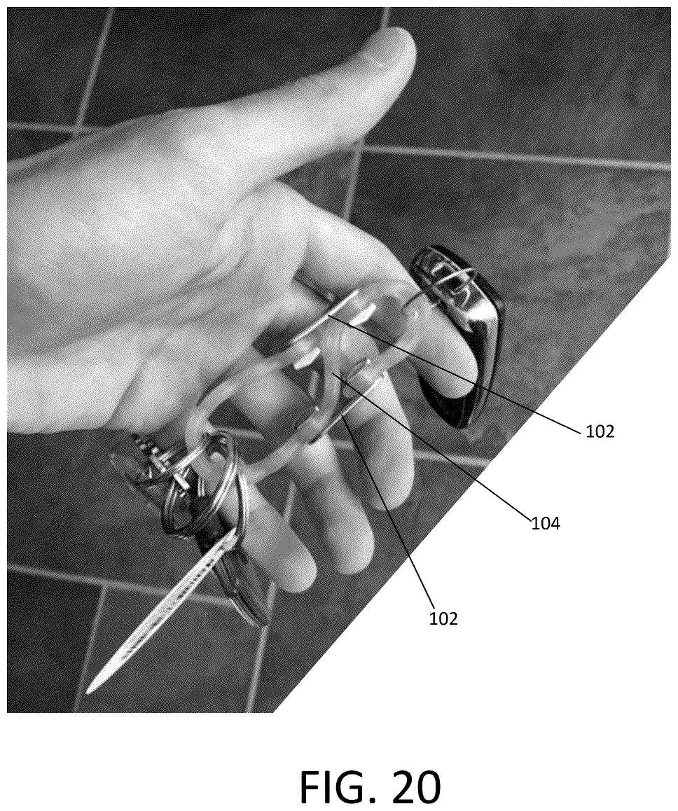

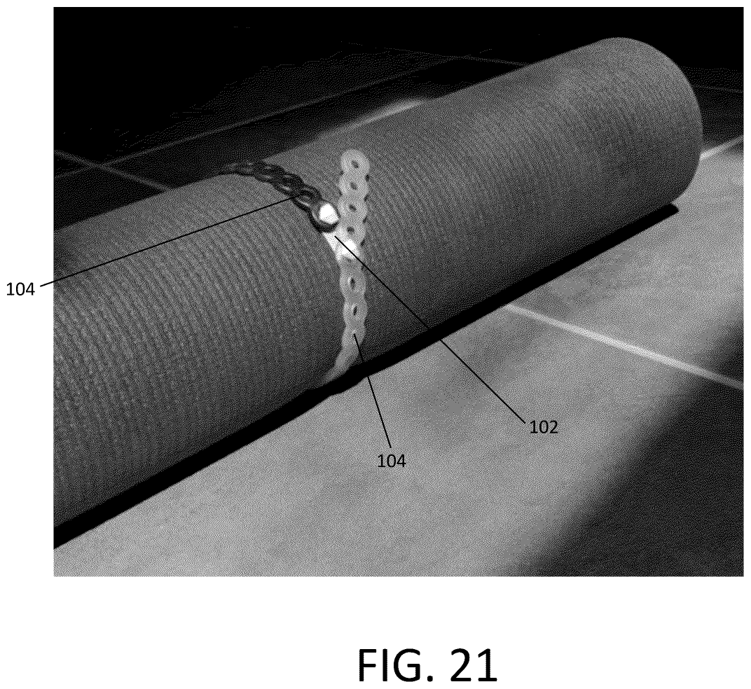

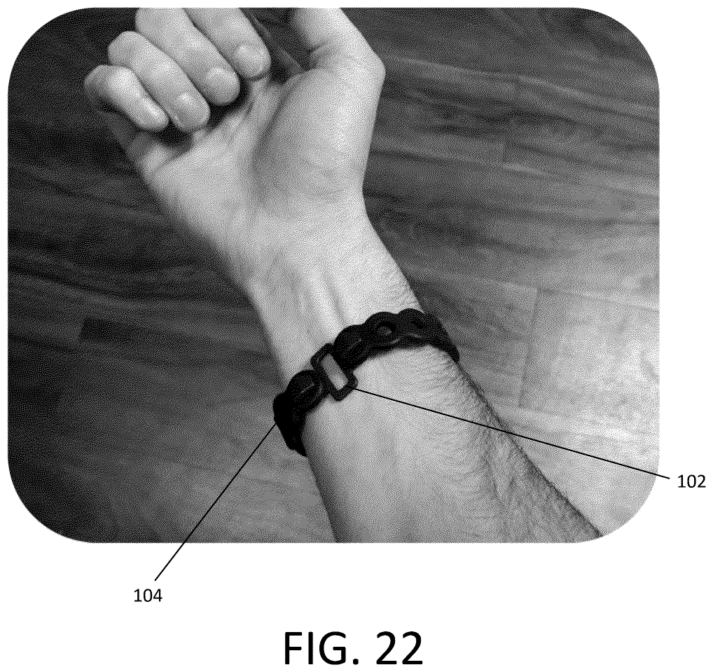

A wide variety of constructs can be formed with the modular utility tool 100 and components thereof. For example, bracelets, wristbands, carabineers, keychains, ties, tethers, tie downs, hoops, retaining straps, lanyards, etc. can be formed. A few example constructs and uses thereof are illustrated in FIGS. 20-22. In FIG. 20, a single strap 104 is formed into a generally “S” or number “8” shape using two link elements 104 in order to form two adjacent loops that can be used as a keychain. In FIG. 21, two straps 104 are joined using two link elements 104 to secure a rolled up yoga mat for easy carrying. Note that the second link is behind the rolled yoga mat. FIG. 22 illustrates a single strap 104 and link 102 forming a bracelet around the wrist or arm of a person.

The following are non-limiting example applications of the modular utility tool 100 in use:
Carabineer;
Loop two kayak/canoe paddles together;
Hang stuff from Ridgeline of hammock;
Bracelet (adjustable and customizable);
Gear Strap (e.g., travel, bike, bike-packing, off-roading, motorcycle, ski gear (boots, helmet, gloves, etc.) to tie gear together;
Toy;
Fidget toy;
Object holder;
Dog collar;
Camping silverware tie;
Fishing rod holder;
Loop for a MOLLE system;
Pick holder for guitarist;
Carry strap for skates/skateboard, etc. without scratching finish;
Climbing rope tie;
Holder on outside of backpacking pack (holds cups/mugs, silverware, dirty shoes, clothes to dry, towel;
Flashlight and/or lantern holder;
Bear bag hanger; and
Hanger for backpack on branch or other member.

Constructs can also be formed via use of more than one link element 102 and/or more than one strap 104. Any number of straps 104 and links 102 can be joined together to form a construct adapted for a particular application.

Further constructs can be formed by joining additional components to the modular utility tool 100. For example, hooks can be inserted through one or more of the apertures 122 in the strap 104.

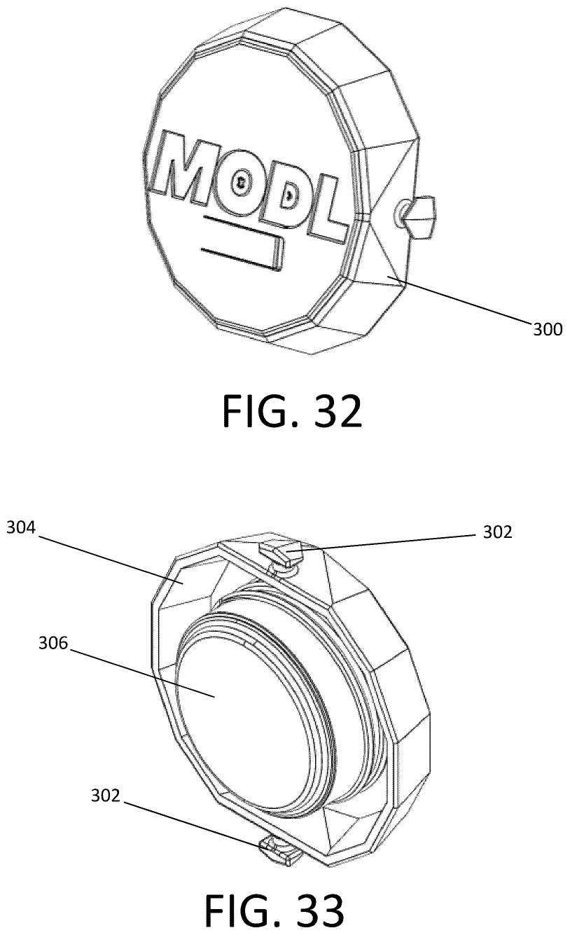

In a further embodiment, the link element 102 can be embodied as a light accessory 300, such as shown in FIGS. 32-37. In this case, the light accessory is in the form of a bottle cap that can be threaded onto a bottle in a utility bottle system such as disclosed in U.S. Pat. No. 11,261,005. U.S. Pat. No. 11,261,005 is hereby incorporated herein by reference in its entirety. This light accessory can transform the bottle into a lantern. Or, the light accessory can be used as a stand-alone light device. The flexible strap 104 can be secured to the studs 302 protruding from the opposing sides of the light accessory 300. This allows the light to be secured to various locations to function as a lantern or flashlight as desired by the user. Of course, the light accessory can be configured without the bottle features in alternative embodiments.

As can be seen in FIGS. 32-37, the inside of the cap body 304 comprises a compartment 306 that is sized and shaped to enclose a puck-shaped light device inside of the compartment. The compartment 306 is water-tight to protect the light device. An On/Off actuator 308 and brightness adjustment actuator 310 are disposed on an outside surface of the cap body 304. The brightness adjustment actuator 310 can also be used to initiate a flashing setting. A color LED or LEDs can be provided to allow for color changing of the light. One of the buttons 308 or 310, or an additional button, can be used to change colors in such embodiments. A sound sensor can be included so that the lights can change colors and/or flash to the beat of music sensed by the sensor.

The light accessory can be formed of a rigid plastic material. The light element can be a commercially-sourced puck light that utilizes light emitting diodes (LEDs). The compartment 306 can be permanently sealed so that the light element is not removable. Alternatively, the inner and outer portions of the cap body 304 can be separated so that the light element can be replaced, or so that the power source (e.g. battery) for the light source can be replaced. The two halves can be held together via suitable means, such as mating male/female threads respectively, a snap fit, etc.

An external port can also be provided to the external surface of the cap body 304 so that a power conduit (e.g., a USB cable or other similar cable) can be attached to recharge a battery that powers the light. The light can also be operated via the conduit directly. In another alternative, the battery can be configured for touchless charging via commercially-available protocols for personal electronics.

A speaker or other sound emitter (e.g., piezoelectric emitter) can be provided in the compartment 306, either with or without the light source. This will allow the cap accessory 300 to play music, sound alarms or make other sounds as desired by the user. The speaker or emitter can be wirelessly (or wired via conduit as noted above) coupled to a user's smartphone or other personal computing device (e.g. via Bluetooth) to play the sounds and/or music.

A global positioning system (GPS) tracking device can be provided to the compartment 306. This will allow the user (or other persons) to track the location of the cap accessory and anything to which it is attached.

In use, the light accessory cap 300 is secured to a bottle, for example via threaded connection with the cap body 304, and the light device illuminates the bottle body to function as a lantern. A flexible strap can be secured to the studs 302 to allow the lantern to hang from a tree branch, tent support pole or other convenient item. In another use example, the cap can be removed and one or more flexible straps can be joined together to allows the user to wear the light accessory on their head to function as a head-mounted light. Many other uses will be apparent and possible with various combinations of the light accessory 300, flexible straps 104 and link elements 102.

Various materials have been identified for construction of all or part of the components described herein. However, other acceptable materials are envisioned for use as well. For instance, while polypropylene, silicone, and stainless steel have been identified, other materials can be employed without deviating from the spirit and scope of the present invention.

While the invention has been described in connection with what is presently considered to be the most practical and preferred embodiments, it will be apparent to those of ordinary skill in the art that the invention is not to be limited to the disclosed embodiments. It will be readily apparent to those of ordinary skill in the art that many modifications and equivalent arrangements can be made thereof without departing from the spirit and scope of the present disclosure, such scope to be accorded the broadest interpretation of the appended claims so as to encompass all equivalent structures and products. Moreover, features or aspects of various example embodiments may be mixed and matched (even if such combination is not explicitly described herein) without departing from the scope of the invention.

What is claimed is:

1. A modular utility tool, comprising:
a flexible strap, comprising an elongated body in a longitudinal direction that includes a plurality of apertures defined therethrough perpendicular to the longitudinal direction; and
a link, comprising a first strap attachment stud and a second strap attachment stud,
wherein each of the first and second strap attachment studs comprises a neck portion and an enlarged head portion,
wherein the head portion defines a diameter greater than the neck diameter and greater than a diameter of the apertures defined through the flexible strap.

2. The modular utility tool of claim 1, wherein the elongated body of the flexible strap comprises a series of adjacently-disposed donut-shaped portions that are connected on opposing sides with an adjacent donut portion, and wherein the plurality of apertures are defined as holes centered in each donut-shaped portion.

3. The modular utility tool of claim 1, wherein the link comprises a rigid planar plate, and wherein the first strap attachment stud and the second strap attachment stud each protrude from a common planar side of the rigid planar plate.

4. The modular utility tool of claim 1, wherein the head portion of each of the first and second strap attachment studs is spade-shaped.

5. The modular utility tool of claim 1, wherein the head portion of each of the first and second strap attachment studs comprises a flat side and an opposing pointed side.

6. The modular utility tool of claim 5, wherein the head portion of each of the first and second strap attachment studs further comprises a pair of parallel sides that span between the flat side and the pointed side.

7. The modular utility tool of claim 6, wherein each intersecting corner of the head portion of each of the first and second strap attachment studs is rounded off.

8. The modular utility tool of claim 1:
wherein the link comprises a plate, including a pair of opposing broad sides,
wherein the first strap attachment stud and the second strap attachment stud each protrude from a common one of the opposing broad sides of the plate, and
wherein a rectangular aperture is defined through the plate in a location between the first and second strap attachment studs.

9. The modular utility tool of claim 8, wherein the rectangular aperture is longitudinally centered between the first and second strap attachment studs.

10. The modular utility tool of claim 8, wherein the rectangular aperture has rounded corners.

11. The modular utility tool of claim 8, wherein the rectangular aperture is oriented perpendicular to a longitudinal length of the plate.

12. The modular utility tool of claim 8, wherein the rectangular aperture is sized to allow the flexible strap to pass therethrough.

13. The modular utility tool of claim 8, wherein the link comprises a slot defined in a perimeter of the plate body to define an opening into the rectangular aperture.

14. The modular utility tool of claim 1, wherein the head portion of each of the first and second strap attachment studs is circular-shaped.

15. The modular utility tool of claim 1, wherein the head portion of each of the first and second strap attachment studs comprises a longitudinally inward facing side and a longitudinally outward facing side when viewed from a rear side of the modular utility tool, wherein the inward facing side is more elongated than the outward side.

16. The modular utility tool of claim 15, wherein the inward facing side defines a flat distal surface connected to a base via a pair of adjacent facets on both an upper side and a lower side thereof, and wherein a width of the inward facing side narrows as it extends from the base towards the flat distal surface.

17. The modular utility tool of claim 16, wherein the outward facing side shares a common base with the inward facing side and tapers as it extends to a distal outward surface via a pair of linear sidewalls.

18. The modular utility tool of claim 17, wherein, in a top elevation view, the head portion of each of the first and second strap attachment studs have a thickest portion at a midline and taper thinner toward the respective flat distal surface and distal outward surface.

19. The modular utility tool of claim 1, wherein the link comprises a light accessory in the form of a bottle cap, wherein the first strap attachment stud and the second strap attachment stud each protrude from the bottle cap in a direction opposite one another.

20. The modular utility tool of claim 19, wherein a compartment is disposed on an inside of the bottle cap, and wherein a light is disposed inside of the compartment.
